(19) United States
(12) Patent Application Publication
(10) Pub. No.: US 2005/0240464 A1
(43) Pub. Date: Oct. 27, 2005

(54) Computer-implemented method and system for improving customer satisfaction with a product

(75) Inventors: Scott Borovich, Beverly Hills, MI (US); Craig Bonk, (US); Steven Hallman, Waterford, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 10/831,832

(22) Filed: Apr. 26, 2004

(51) Int. Cl. G06F 17/60

(52) U.S. Cl. 705/10

(57) ABSTRACT

A method and system for improving customer satisfaction with a product. The method and system may be implemented after the product reaches the market to improve customer satisfaction with the product. The method and system is computer-implemented for electronically evaluating customer satisfaction ratings for a product to determine a low-rated feature of the product. A computer database is electronically searched for a product change to the low-rated feature of the product that, if implemented, would improve customer satisfaction for the low-rated feature.

### BACKGROUND OF THE INVENTION

1. Field of the Invention

The present invention relates to methods and systems for improving customer satisfaction of a product after the product reaches the market.

2. Background Art

Product manufacturers desire to manufacture products having high customer satisfaction. The advantages of high customer satisfaction are numerous, including repeat sales and brand-name recognition. Manufacturers may perform market analysis and other studies to determine products that are likely to achieve high customer satisfaction. The results of the analysis are reviewed and the product is designed.

Such up-front analysis is advantageous for determining the products that are likely to achieve high ratings. The analysis is not foolproof. The true test of customer satisfaction comes after the product reaches the market and sales are made. Further analysis can be performed after the product reaches the market to determine actual customer satisfaction with the completed product.

The after-market analysis allows the manufacturers to determine features of the product contributing to high and low customer satisfaction. The manufacturer can improve low-rated products by changing the low-rated features of the product. It is desirable to change the low-rated features to recoup the advantages of high customer satisfaction.

The cost to develop tooling and hire personnel to design and manufacture a product can be high. The manufacturers are less likely to spend additional resources to change the product after it reaches the market, as the product cost structure is already set and the cost to change the product can include duplicative allocation of the same resource spent in bringing the product to market.

Suppliers of components of the product can increase sales volume and penetrate new markets if they can sell the manufacturers on changing the product to improve its customer satisfaction rating. Accordingly, a need exists for a method to sell manufacturers on the desirability of changing low-rated features after the product reaches the market so that the product can be changed to improve its customer satisfaction rating.

### SUMMARY OF THE INVENTION

The present invention meets the above-identified need with a method and system to improve customer satisfaction of a product after the product reaches the market.

The present invention provides the supplier with an electronic tool for demonstrating to the manufacturer the cost of implementing changes to the product in light of improved customer satisfaction ratings. The manufacturers can weigh the cost to improve customer satisfaction against the cost of continuing to produce a low-rated product or features of the product to determine whether to implement the product change.

The present invention contemplates a number of features and configurations, including a system having a computer in communication with a database. The computer is configured to electronically search and manipulate data in the database. The database includes customer satisfaction ratings for a product after the product is introduced to the market and details on a number of supplier produced components which may be operable with the product. An operator instructs the computer to select one of the products for evaluation, whereby the computer entered determines a low-rated feature of the product based on the customer satisfaction ratings. The low-rated feature has a customer satisfaction rating less than a desired customer satisfaction rating. The computer then electronically searches the database for a product change that improves the customer satisfaction rating for the low-rated feature.

In one aspect of the present invention, the computer searches the database for a component product change. The component product change selects a component produced by the supplier which can be substituted for one of the components in the product to improve customer satisfaction.

In another aspect of the present invention, the computer searches the electronic database for an engineering solution product change. The engineering solution product change can be a component or non-component change which is based on the supplier's experience with improving customer satisfaction for the low-rated feature.

One aspect of the present invention relates to the computer generating a data output, such as a spreadsheet, to illustrate the improved customer satisfaction ratings achieved by implementing the supplier's product change. The spreadsheet may include a value of improved customer satisfaction that reflects an anticipated improvement in customer satisfaction for the low-rated feature due to a product change.

The spreadsheet may further include a section which details an overall customer satisfaction rating for the product prior to implementation of the product change with customer satisfaction ratings for the product after the product change to provide a comparison of improved customer satisfaction.

The spreadsheet may further include a section that indicates the cost per vehicle of implementing the product change. The manufacturer can review the cost to implement the product change against their current cost structure to determine whether the improvement in customer satisfaction warrants making the product change.

The spreadsheet may still further include a section showing overall customer satisfaction ratings for vehicles in a similar market to provide a market comparison of the manufacturer's vehicle against other vehicles in a similar market.

### BRIEF DESCRIPTION OF THE DRAWINGS

FIG. 1 illustrates a computer-implemented system for improving customer satisfaction in accordance with the present invention;

FIG. 2 illustrates a flow chart of a method for improving customer satisfaction of a product in accordance with one aspect of the present invention;

FIG. 3 illustrates an exemplary spreadsheet which can be used for reporting customer surveys of a product; and

FIG. 4 illustrates a product change spreadsheet for demonstrating improved customer satisfaction in accordance with the present invention.

### DETAILED DESCRIPTION OF THE PRESENT INVENTION EMBODIMENTS

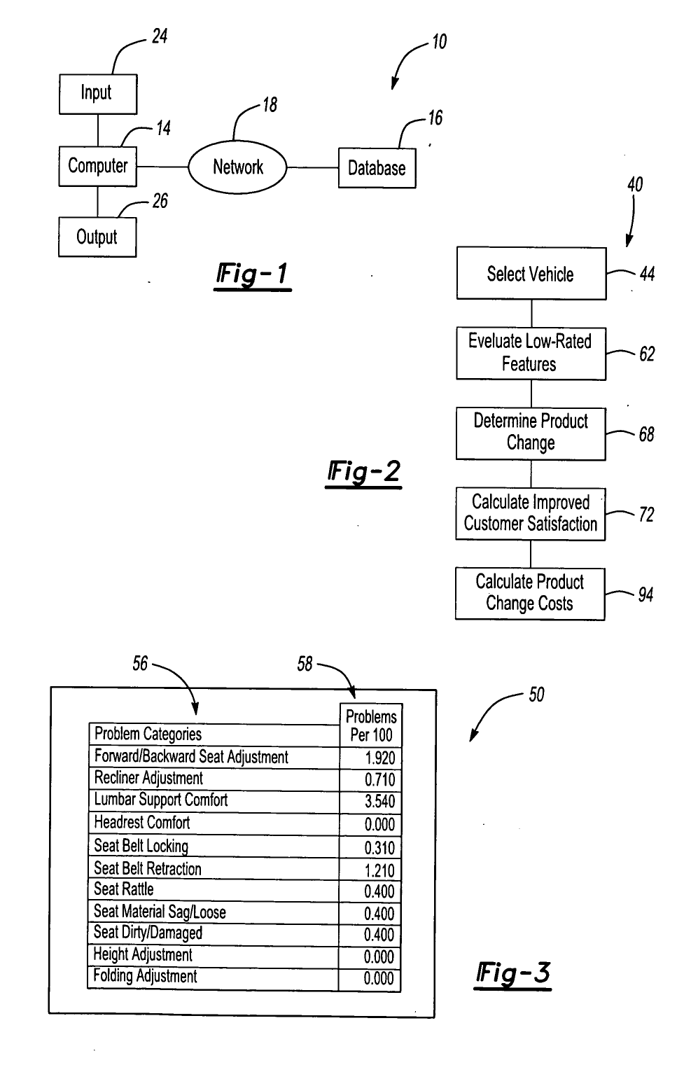

FIG. 1 illustrates a system 10 for improving customer satisfaction in accordance with the present invention. The present invention contemplates that the system 10 includes any number of items, including a computer 14 and a database 16. The database 16 can be part of the computer 14 or, as shown, connected to the computer 14 over a network 18.

The computer 14 includes an input device 24 and an output device 26. The input device 24 can be a keyboard or other data entry device. The output device 26 can be a monitor, printer, or other medium, such as a web page. The computer 14 includes a microprocessor (not shown) or other processing means. The microprocessor is configured to receive data from the database 16 and the input device 24 and to provide outputs to the output device 26.

The microprocessor contains arithmetic, logic, and control one or more circuitry needed to function as a processing unit. The microprocessor includes integrated circuits that can interpret and execute program instructions, as well as handle arithmetic operations. The microprocessor executes any number of logic operations, such as adding, subtracting, and copying. A set of instructions in the microprocessor tells the microprocessor how to execute the methods of the present invention, but different applications and input devices may be used to give instructions to the microprocessor.

The scope of the present invention is not intended to be limited to the structures and the system 10 shown in FIG. 1. Rather, it is within the contemplation of the present invention to use other configurations and arrangements that may include more or less of the illustrated items, features, and devices.

FIG. 2 illustrates a flowchart 40 for a method of improving customer satisfaction of a product after it reaches the market. The method is computer-implemented so that suppliers to product manufacturers can electronically determine improvements in customer satisfaction from changes to the product and express these improvements with a tool which assists the suppliers in selling the manufacturer on changing the product.

The method is described with respect to an exemplary embodiment wherein the supplier provides components to the product manufacturer which the product manufacturer assembles into a completed product. For the purposes of the exemplary embodiment, the supplier provides components to a vehicle manufacturer which the vehicle manufacturer assembles into a vehicle. The description is only exemplary and is not intended to limit the scope of the present invention.

The cost to develop tooling and hire personnel to design and manufacture the vehicle can be high. The manufacturers are less likely to spend additional resources to change the vehicle after it reaches the market as the vehicle cost structure is already set and the cost to change the vehicle can include duplicative allocation of the same resource spent in bringing the product to market.

Suppliers of components of the vehicle can increase sales volume and penetrate new markets if they can sell the manufacturers on changing the vehicle after it reaches the market to include the supplier's components if the changes improve customer satisfaction of low-rated features of the vehicle. The manufacturers can change such low-rated features to improve overall customer satisfaction with the vehicle to take advantage of the benefits of improved customer satisfaction.

Up until the present invention, a need existed for computer-implemented methods and systems to sell the manufacturers on the desirability of changing low-rated features of the product after the product reaches the market. The present invention meets this need with a computer-implemented method and system that demonstrates to the supplier the cost of implementing changes to the product in light of improved customer satisfaction ratings. The manufacturers can weigh the cost to improve customer satisfaction against the cost of continuing to produce a low-rated product or features of the product to determine whether to implement the product change.

A block 44 relates to identifying a vehicle and inputting customer satisfaction ratings for the identified vehicle into the computer. The customer satisfaction ratings for the product can be received electronically by the computer in the form of customer satisfaction surveys and the like.

One source for customer surveys is JD Powers. JD powers can provide a breakdown of customer satisfaction ratings for each feature on the vehicle. The customer satisfaction ratings can also be determined by the supplier conducting its own customer surveys.

FIG. 3 illustrates an exemplary spreadsheet 50 of results of a customer survey which can be stored in physical media in the computer and inputted thereto either manually or electronically over a network or computer connection to the Internet. The spreadsheet 50 breaks down customer satisfaction of various features of the vehicle according to a number of predefined categories 52.

The features shown in FIG. 3 relate to seating. Other features could also be included without deviating from the scope and contemplation of the present invention, such as ride and handling, vehicle controls, sound systems, heating and air conditioning, vehicle exterior, vehicle interior, transmission, engine, and the like.

The seating customer satisfaction survey breaks down customer dissatisfaction with respect to a number of common problems with the seating features, as shown in a column 56. The exemplary categorization shown in FIG. 3 indicates customer satisfaction with forward/backward seat adjustment, recliner adjustment, lumbar support comfort, headrest comfort, seat belt locking, seat belt retraction, seat rattle, seat material sag/loose, seat dirty/damaged at delivery, height adjustment, folding adjustment, and the like.

Customer dissatisfaction can be determined in any number of ways, and generally, is determined by the customer rating their satisfaction with the feature with a value less than a predefined acceptable value. For example, the customer survey may ask the customer to rate forward/backward seat adjustment with values of 1 to 5. Ratings of less than 3 can correlate to a problem rating.

The computer 14 stores the number of problem ratings in terms of problems per hundred vehicles and outputs the data into the spreadsheet 50, as shown in a column 58. Column 58 indicates 1.92 problems with forward/backward adjustment for every one-hundred customers surveyed with respect to the vehicle selected in the block 54. Similar values are indicated for each category shown in FIG. 3.

Returning to FIG. 2, a block 62 relates to evaluating the problem ratings shown in the column 58 to determine low-rated seating features. The low-rated features can be determined in a number of ways. The present invention determines low-rated features to be those which have problem ratings above a predefined number per one-hundred customers.

Low-rated features can be determined for each category having problem values of one or more. The features shown in FIG. 3 reaching this threshold include forward/backward adjustment, poor/uncomfortable lumbar support, and seat belt retraction. It is desirable to improve the customer satisfaction of these features by changing one or more components of the vehicle which are responsible for the dissatisfaction.

A block 68 relates to the computer electronically searching within the database 16 to locate a product change which can be implemented to improve customer satisfaction with respect to the low-rated feature(s).

In one aspect of the present invention, the block 68 is executed by configuring the database to include an inventory of the various seating components and seating systems produced by the seating supplier. A detailed description of the inventory is inputted both graphically and textually in the database so that the computer can electronically scan and search the database to determine which of the supplier's seating components are operable with the vehicle identified in the block 44.

The computer 14 then further evaluates which one or more of the supplier's components that are operable with the vehicle could be used to ameliorate the number of problems reported for the low-rated feature(s), i.e., to improve its customer satisfaction rating. One component change for the low-rated forward/backward retraction may include changing a retraction device from a manually-operated means to an automated or electric means.

The computer 14 can select the substitutable components for the product change, for example, by analyzing historical customer satisfaction ratings for the supplier's components and determining from the component's details which one or more of the supplier's components would improve customer satisfaction. The historical customer satisfaction ratings for he supplier's components can be determined in a manner similar to that described above by inputting previously conducted JD Powers surveys and/or the supplier conducting their own surveys.

The historical data indicates past customer ratings for the supplier's components, whereby the supplier's components which have lower problem ratings per one-hundred vehicles than that which was received by the low-rated component(s) are selected by the computer as being substitute components for the vehicle which may be used to improve customer satisfaction of the low-rated feature(s). The one or more substitutable components for each low-rated feature can be incorporated into a product change to improve the customer satisfaction rating of the low-rated feature, and thereby, improve the overall customer satisfaction rating of the vehicle.

In another aspect of the present invention, the block 68 is executed by configuring the database to include engineering solutions generated by the supplier for the problem categories listed in the column 54 of FIG. 3. The engineering solutions relate to solutions which have worked in the past to ameliorate the number of problems reported in the various categories. Historical data is included with the engineering solutions to indicate the problem ratings which the engineering solutions have achieved. The engineering solutions include graphical and textual descriptions of the solutions and are inputted into the database over time. The engineering solutions which achieve lower problem ratings than those received by the low-rated feature(s) are selected by the computer 14 as being suitable for the product change.

The engineering solutions can include both component and non-component changes to the products which serve to ameliorate the number of reported problems. With respect to the low-rated feature being forward/backward retraction, one non-component change engineering solution may include changing a track lubrication for a track in which the retraction occurs. This engineering solution permits the use of the same vehicle components providing the forward/backward retraction while at the same time improving customer satisfaction. A component change engineering solutions for the same problem may include changing the lubricant and changing the track to a track having a wider channel in which retraction occurs.

Block 72 relates to computer 14 calculating a value of improved customer satisfaction with respect to the low-rated feature(s) for the product change determined in block 62. The value of improved customer satisfaction is determined as a function of the historical data for the product change. In one aspect of the present invention, the value of improved customer satisfaction is calculated by the computer inserting the historical customer satisfaction rating.

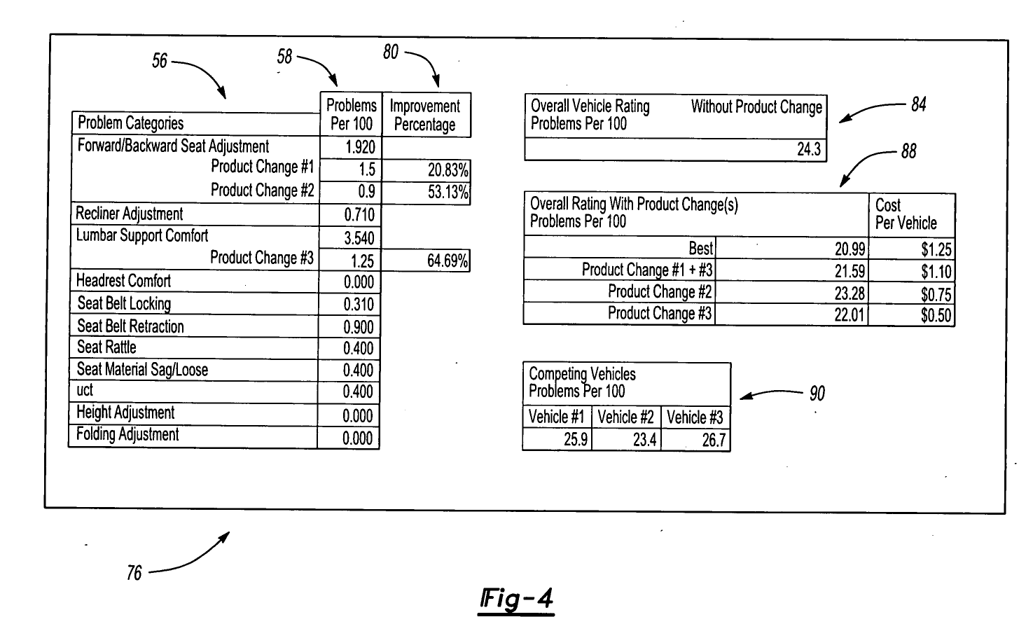

The value of improved customer satisfaction is outputted by the computer 14 in a product change spreadsheet 76 shown in FIG. 4. The product change spreadsheet 76 includes a row under each category 56 with a title for the product change and a value indicating its improved customer satisfaction rating. Multiple product changes can be included for each category. A column indicates a percentage improvement in customer satisfaction for the product change over the low-rated feature.

Section 84 includes an overall customer satisfaction for the vehicle based on the features shown in FIG. 3 and other features not shown in FIG. 3, but included with the customer survey for the vehicle. The computer determines these values from the survey data.

Section 88 shows an overall customer satisfaction for the vehicle based on selectable product changes. The computer 14 can be programmed to calculate the improvement in overall customer satisfaction as a function of the number of low-rated features changed by the product change and the value of improved customer satisfaction associated with each changed feature.

Section 90 further compares the value of overall improvement in customer satisfaction to satisfaction ratings for vehicles in a similar market—this data can inputted from JD Powers or by a user. The comparison to other vehicles in the market provides a market comparison.

Referring to FIG. 2, a block 94 relates to the computer 14 calculating a cost to implement each product change. The computer can determine the cost from historical cost data and from user inputs. The product change costs are shown in section 88 of FIG. 4. Positive values indicate additional component or supply costs to implement the product change and negative values indicate a reduction in such costs. An optional column (not shown) can be included in section 88 if the current cost per vehicle of the low-rated feature is known to show a comparison of the costs before and after the product change.

The manufacturer can review these costs to determine whether it is desirable to implement the product change. The supplier may be able to adjust the product change cost by offering the manufacturer volume discounts or system discounts. The system discount may be advantageous if the supplier provides additional components beyond the components needed to improve customer satisfaction with respect the low rated features. This can include the supplier offering a product change which changes a component relating to the low-rated feature and a second component related to a non-low-rated feature, whereby the supplier is able to offer a lower system cost due to the product change including the second component.

The computer 14 can be configured in a manner similar to that described above with respect to the low-rated features to determine product changes which incorporate changes to non-low-rated feature(s) in order to package the additional product change to the non-low-rated feature(s) with the change to the low-rated feature so that further cost savings can be achieved.

The product change spreadsheet 76 provides a unique tool for selling manufacturers on the desirability of changing their product to include the supplier's components by demonstrating to the manufacturer the cost to change the product and the corresponding benefit in customer satisfaction which is anticipated to result from the product change. The manufacturers can then weigh the desirability of making the product change.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A computer-implemented method for improving customer satisfaction with a product after the product is introduced to a market, the method comprising:
receiving customer satisfaction ratings for one or more features of the product after the product is introduced to the market;
determining a low-rated feature of the product based on the customer satisfaction ratings, the low-rated feature having a customer satisfaction rating less than a desired customer satisfaction rating for the feature; and
electronically searching a computer database for a product change that improves the customer satisfaction rating for the low-rated feature.

2. The method of claim 1 further comprising implementing the product change by changing at least one component of the product.

3. The method of claim 1 further comprising electronically determining a value of improved customer satisfaction value that reflects an anticipated improvement in customer satisfaction for the low-rated feature due to the product change.

4. The method of claim 3 further comprising determining the improved customer satisfaction value from historical customer satisfaction ratings for the product change stored in the database.

5. The method of claim 4 further comprising determining an overall customer satisfaction rating for the product, the overall customer satisfaction rating being a function of the customer satisfaction ratings received for the features of the product and the improved customer satisfaction value from the product change.

6. The method of claim 5 further comprising receiving customer satisfaction ratings for additional products in a similar market, and the method further comprising comparing the overall customer satisfaction rating for the product to the customer satisfaction ratings for the additional products to provide a competitive analysis of the product to other products in the market.

7. The method of claim 4 further comprising electronically determining a cost to implement the product change.

8. The method of claim 1 wherein electronically searching for the product change includes selecting a component product change.

9. The method of claim 1 wherein electronically searching for the product change includes selecting an engineering solution product change.

10. The method of claim 9 further comprising configuring the computer database to include component details on a number of components that are operable with the product, wherein electronically searching the database includes electronically searching through the component details for components having details corresponding with the low-rated component to determine one or more of the database-described components that can be substituted for the low-rated component to implement the product change.

11. A computer for improving customer satisfaction with a product, the computer configure to:
receive customer satisfaction ratings for one or more features of the product;
evaluate the customer satisfaction ratings to determine a low-rated feature of the product, the low-rated feature having a customer satisfaction rating less than a desired customer satisfaction rating; and
search a database for a product change that improves the customer satisfaction rating for the low-rated feature.

12. The computer of claim 11 configured to calculate a value of improved customer satisfaction that reflects an anticipated improvement in customer satisfaction for the low-rated feature due to the product change.

13. The computer of claim 12 configured to calculate the value of improved customer satisfaction from historical customer satisfaction ratings for the product change stored in the database.

14. The computer of claim 13 configured to determine an overall customer satisfaction rating for the product, the overall customer satisfaction rating being a function of the customer satisfaction ratings received for the features of the product and the value of improved customer satisfaction from the product change.

15. The computer of claim 14 configured to receive customer satisfaction ratings for additional products in a similar market, and the computer further configured to compare the overall customer satisfaction rating for the product to the customer satisfaction ratings for the additional products to provide a competitive analysis of the product to other products in the market.

16. The computer of claim 11 configured to calculate a cost to implement the product change.

17. The computer of claim 16 configured to generate a data output that includes a comparison of the cost to implement the product change with the value of improved customer satisfaction.

18. The computer of claim 11 wherein the database includes component details on a number of components that are operable with the product, wherein the computer is configured to search through the component details for components having details corresponding with the low-rated component to determine one or more of the database described components that can be substituted for the low-rated component.

19. A computer-implemented method for improving customer satisfaction with a product, the method comprising:
receiving customer satisfaction ratings for one or more features of the product;
evaluating the customer satisfaction ratings to determine a low-rated feature of the product, the low-rated feature having a customer satisfaction rating less than a desired customer satisfaction rating; and
electronically searching a database having details for a number of components that are operable with the product to select at least one substitute component that can be substituted for at least one component of the product to improve the customer satisfaction rating for the low-rated feature.

20. The method of claim 19 further comprising electronically calculating a value of improved customer satisfaction from historical customer satisfaction ratings for the substituted component stored on database that reflects an anticipated improvement in customer satisfaction for the low-rated feature due to the product change.
